(19) United States
(12) Patent Application Publication
(10) Pub. No.: US 2016/0239962 A1
(43) Pub. Date: Aug. 18, 2016

(54) SYSTEM AND METHOD TO OBJECTIVELY MEASURE QUALITY ASSURANCE IN ANATOMIC PATHOLOGY

(71) Applicant: Prairie Ventures, LLC, Omaha, NE (US)

(72) Inventors: Rodney S. Markin, Omaha, NE (US); Mark L. Priebe, Palm Bay, FL (US)

(21) Appl. No.: 15/042,232

(22) Filed: Feb. 12, 2016

Related U.S. Application Data
(63) Continuation-in-part of application No. 14/826,962, filed on Aug. 14, 2015.
(60) Provisional application No. 62/237,816, filed on Oct. 6, 2015.
(60) Provisional application No. 62/115,996, filed on Feb. 13, 2015.

(51) Int. Cl. G06T 7/00; G06K 9/52; G06K 9/46; G06T 7/40; G06K 9/62; G06K 9/20

(52) U.S. Cl. CPC G06T 7/0012; G06K 9/6202; G06K 9/2054; G06K 9/4652; G06T 7/408; G06K 9/52

(57) ABSTRACT

Techniques are described that facilitate generation of a practice proficiency score related to the quality of a pathology department processes (e.g., quality of/accuracy of pathologist diagnoses, etc.). In one or more implementations, a method may comprise generating an assessment metric based upon a comparison of the first image attribute with a second image attribute. The first image attribute comprises an attribute associated with a digital image representing a specimen. The method also includes receiving a diagnostic confidence metric corresponding to the specimen. The method also includes receiving a diagnostic accuracy metric corresponding to the specimen. The method also includes receiving a turn around time metric corresponding to the specimen. The method also includes receiving a clerical accuracy metric corresponding to the specimen. The method also includes causing a processor to generate a score representing a proficiency corresponding to the specimen. The score is based upon the assessment metric, the diagnostic confidence metric, the diagnostic accuracy metric, the turn around time metric, and the clerical accuracy metric.

### BACKGROUND

Anatomical (or anatomic) pathology is a medical specialty concerned with the diagnosis of disease based upon macroscopic, microscopic, biochemical, immunologic, and molecular examination of organs and tissues.

### SUMMARY

Techniques are described that facilitate generation of a practice proficiency score related to the quality of a pathology department processes (e.g., quality of/accuracy of pathologist diagnoses, etc.). In one or more implementations, a method may comprise determining a first image attribute of a digital image of a specimen based upon at least one image characteristic of the digital image, the digital image captured by an image capture device and generating an assessment metric based upon a comparison of the first image attribute with a second image attribute provided by a client device. The method also includes receiving a diagnostic confidence metric corresponding to the specimen. The diagnostic confidence metric comprises an indication of whether a second review of the specimen occurred. The method also includes receiving a diagnostic accuracy metric corresponding to the specimen. The diagnostic accuracy metric comprises an accuracy indication of a diagnosis of the anatomic pathology specimen. The method also includes receiving a turn around time metric corresponding to the specimen. The turn around time metric comprises a time ranging from a case accession time to a case sign out time. The method also includes receiving a clerical accuracy metric corresponding to the specimen. The clerical accuracy metric comprises a clerical accuracy parameter pertaining to the specimen. The method also includes causing a processor to generate a score representing a proficiency corresponding to the specimen. The score is based upon the assessment metric, the diagnostic confidence metric, the diagnostic accuracy metric, the turn around time metric, and the clerical accuracy metric.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1A is an illustration of an environment in an example implementation that includes a server operable to generate a practice proficiency score in accordance with an example implementation of the present disclosure.

FIG. 1B is an example graphical representation of an alert displayed within an unobscured portion of a display of a client device in accordance with an example implementation of the present disclosure.

FIG. 1C is an example graphical representation of an alert displayed within a display of a client device in accordance with an example implementation of the present disclosure, where the alert includes a URL link for accessing one or more reports graphically representing a practice proficiency score.

FIG. 2 is an example graphical representation of the practice proficiency score in accordance with an example implementation of the present disclosure.

FIG. 3 is another example graphical representation of the practice proficiency score in accordance with an example implementation of the present disclosure.

FIG. 4 is another example graphical representation of the practice proficiency score in accordance with an example implementation of the present disclosure.

FIG. 5 is another example graphical representation of the practice proficiency score in accordance with an example implementation of the present disclosure.

FIG. 6 is a flow diagram illustrating an example method for generating a practice proficiency score based upon multiple metrics corresponding to a specimen in accordance with an example implementation of the present disclosure.

### DETAILED DESCRIPTION

The term quality assurance refers to the documented evidence that a process or system performs according to predetermined specifications and quality attributes. The practice of anatomic pathology involves performing a subjective interpretation of microscopic tissue characteristics and objective data, and to select specific language to convey a diagnosis. The objective data, contained in the characteristics of the cells, organization of tissues, and relationship to the organ on the whole, are preserved for the initial examination on histologic glass slides or in a digitized image format. Many factors contribute to the lack of objectivity and diagnostic inaccuracy, including the training and skill of the pathologist, quality of the slide, level of pathologist confidence and methods to access the quality of pathology services.

One of the possible contributing factors is the use of an intra-departmental consultation or second opinion method to assess the quality of a pathology service. The College of American Pathologists (CAP) has established guidelines for both intra-departmental and extra-departmental quality consultations. These guidelines appear to have failed to encourage quality assurance activities that result in optimal diagnostic accuracy, consistency in terminology, and timely care for patients. Over the past two decades, several studies have published the rates of diagnostic discrepancy. A discrepancy is defined as: when one pathologist renders a diagnosis and another pathologist looks at the same material and renders a different opinion/diagnosis.

Another likely contributing factor to the subjectivity is the absence of an objective measure to assess the quality of the pre-analytic, analytic and post-analytic processes of the pathology service. Existing standardized scoring quality assurance programs are; External Quality Assurance (eQA) and Proficiency Testing (PT). These existing quality assurance programs are limited in their scope and suffer from lack of granularity and completeness of quality review.

Thus, quality assurance measurements need to be applied across the pre-analytical, analytical and post-analytical diagnostic process to ensure the patient receives the best diagnosis possible. Accordingly, a system is disclosed that generates a practice proficiency score related to the quality of a pathology department process and associated diagnosis related artifacts. The system receives information identifying a case submission; receives information, digital images, and data associated with the case from the laboratory/pathology information system; receives whole-slide imaging files of digital microscopy technologies; receives information related to the quantitative and qualitative analysis performed by an image analysis application; receives quality assurance review of the final diagnosis for accuracy as provided by external reviewers; and causes calculation of an objective measure of pathology service proficiency. The objective measure enables comparable comparisons in generating benchmarking tools that help identify professional strengths and areas of improvement when compared to a matching peer group and practice.

Certain embodiments as disclosed herein provide for systems and methods to objectively measure quality assurance in anatomic pathology. However, although various implementations of the present disclosure are described herein, and presented by way of example specific to anatomic pathology, the disclosure has other embodiments and applicability to other disciplines as to not limit the scope or breadth of the current disclosure. In one embodiment, a system and method of quality assurance that generates a unique Practice Proficiency Score (PPS) that is used to benchmark quality performance in pathology and for medical practice continuous improvement. The program comprises five (5) metrics that may have a role in reducing diagnostic error.

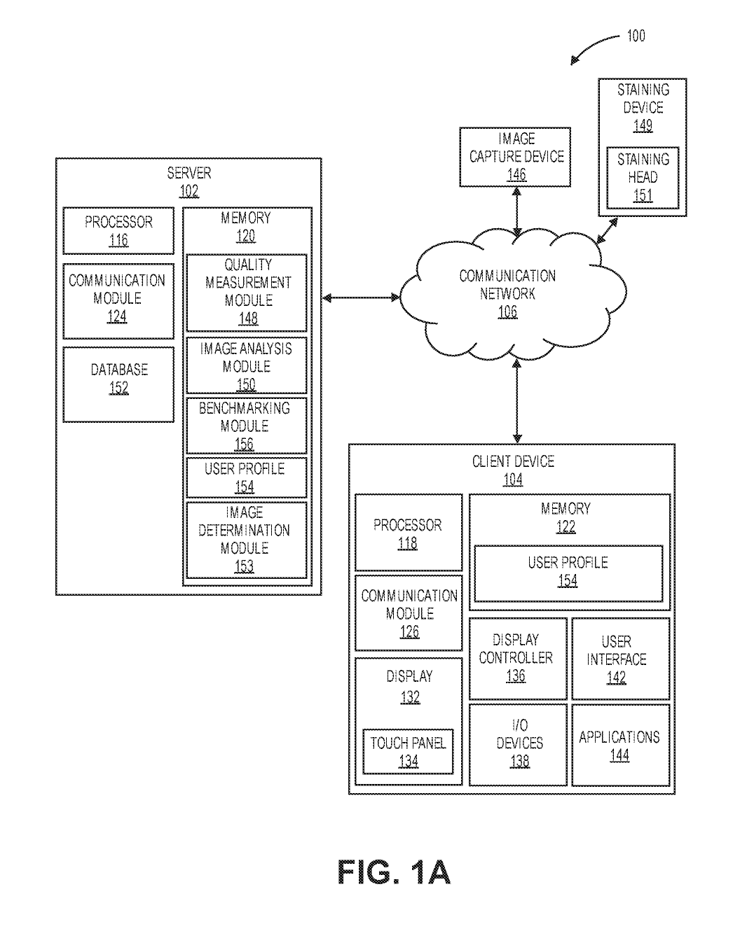

FIG. 1A illustrates an environment 100 in an example implementation that is operable to facilitate generation of an objective measure of pathology service proficiency corresponding to a case in accordance with the present disclosure. The case may comprise one or more metrics relating to a specimen. For example, the specimen may comprise an anatomic pathology specimen and/or a clinical laboratory specimen. The anatomic pathology specimen may include, but is not limited to, specimens used to determine the presence of cancer or dermal disorders. The illustrated environment 100 includes a server 102 and one or more client devices 104 that communicates with the server 102 via one or more networks 106.

The server 102 may be configured in a variety of ways. For example, the server 102 may be configured as one or more server computers that are capable of communicating over a wired or wireless network 106. The client device 104 may also be configured in a variety of ways. For example, the client device 104 may be configured as a computing device independent of the server 102. For instance, the client device 104 may comprise a desktop computing device, a server computing device, a laptop computing device, a tablet, a mobile electronic device, and so forth, that is capable of communicating over a wireless network. Additionally, although one client device 104 is illustrated, it is understood that the server 102 may provide the functionality described herein to multiple mobile electronic devices 104. The client device(s) 104 can be utilized to provide the system 100 one or more of the quality metrics described below.

The network 106 may assume a wide variety of configurations. For example, the network 106 may comprise any of a plurality of communications standards, protocols and technologies, including, but not limited to: a 3G communications network, a 4G communications network, a Global System for Mobile Communications (GSM) environment, an Enhanced Data GSM Environment (EDGE) network, a high-speed downlink packet access (HSDPA) network, a wideband code division multiple access (W-CDMA) network, a code division multiple access (CDMA) network, a time division multiple access (TDMA) network, Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)) environment, an instant messaging (e.g., extensible messaging and presence protocol (XMPP) environment, Session Initiation Protocol for Instant Messaging and Presence Leveraging Extensions (SIMPLE), and/or Instant Messaging and Presence Service (IMPS), and/or Short Message Service (SMS)), or any other suitable communication protocol, that facilitates communication between the server 102 and the client device 104.

In FIG. 1A, the server 102 and the client device 104 are illustrated as including a respective processor 116 or 118, a respective memory 120 or 122; and a respective communication module 124 or 126. In the following discussion, elements of the server 102 are described with reference to FIG. 1A. Respective elements and/or reference numbers related to the client device 104 are shown in parentheses. Where appropriate, elements of the client device 104 are described separately.

The processor 116 (118) provides processing functionality for the server 102 (client device 104) and may include any number of processors, micro-controllers, or other processing systems, and resident or external memory for storing data and other information accessed or generated by the server 102 (client device 104). The processor 116 (118) may execute one or more software programs which implement techniques described herein. The processor 116 (118) is not limited by the materials from which it is formed or the processing mechanisms employed therein and, as such, may be implemented via semiconductor(s) and/or transistors (e.g., electronic integrated circuits (ICs)), and so forth.

The memory 120 (122) is an example of tangible computer-readable media that provides storage functionality to store various data associated with the operation of the server 102 (client device 104), such as the software program and code segments mentioned above, or other data to instruct the processor 116 (118) and other elements of the server 102 (client device 104) to perform the steps described herein. Although a single memory 120 (122) is shown, a wide variety of types and combinations of memory may be employed. The memory 120 (122) may be integral with the processor 116 (118), stand-alone memory, or a combination of both. The memory may include, for example, removable and non-removable memory elements such as RAM, ROM, Flash (e.g., SD Card, mini-SD card, micro-SD Card), magnetic, optical, USB memory devices, and so forth.

The communication module 124 (126) provides functionality to enable the server 102 (client device 104) to communicate with one or more networks (depicted in FIG. 1A as network 106). In various implementations, the communication module 124 (126) may be representative of a variety of communication components and functionality including, but not limited to: one or more antennas; a browser; a transmitter and/or receiver (e.g., radio frequency circuitry); a wireless radio; data ports; software interfaces and drivers; networking interfaces; data processing components; and so forth.

The one or more networks 106 may be representative of a variety of different communication pathways and network connections which may be employed, individually or in combinations, to communicate among the components of the environment 100. Thus, the one or more networks 106 may be representative of communication pathways achieved using a single network or multiple networks. Further, the one or more networks 106 are representative of a variety of different types of networks and connections that are contemplated, including, but not limited to: the Internet; an intranet; a satellite network; a cellular network; a mobile data network; wired and/or wireless connections; and so forth.

Examples of wireless networks include, but are not limited to: networks configured for communications according to: one or more standard of the Institute of Electrical and Electronics Engineers (IEEE), such as 802.11 or 802.16 (Wi-Max) standards, Wi-Fi standards promulgated by the Wi-Fi Alliance; Bluetooth standards promulgated by the Bluetooth Special Interest Group; and so on. Wired communications are also contemplated such as through universal serial bus (USB), Ethernet, serial connections, and so forth.

As shown in FIG. 1A, the client device 104 includes a touch-sensitive display 132, which can be implemented using a liquid crystal display, an organic light emitting diode display, or the like. In some embodiments, the touch-sensitive display 132 may include a touch panel 134. The touch panel 134 may be, but is not limited to: a capacitive touch panel, a resistive touch panel, an infrared touch panel, combinations thereof, and the like. Thus, the display 132 may be configured to receive input from a user and display information to the user of the client device 104. For example, the display 132 displays visual output to the user. The visual output may include graphics, text, icons, video, interactive fields configured to receive input from a user, and any combination thereof (collectively termed “graphics”). In some embodiments, some or all of the visual output may correspond to user-interface objects, further details of which are described below.

The display 132 is communicatively coupled to a display controller 136 that is configured to receive and/or transmit electrical signals to the touch-sensitive display 132. In an implementation, the touch panel 134 includes a sensor, an array of sensors, or the like, configured to accept input from a user based upon haptic and/or tactile contact. The touch panel 134, in combination with the display controller 136 (along with any associated modules and/or sets of computer-readable instructions in memory 122), detects a point of contact (or points of contact), as well as any movement or breaking of the contact, on the touch panel 134 and converts the detected contact (e.g., a finger of the user, a stylus, etc.) into electrical signals representing interactions with user-interface objects (e.g., buttons, custom views, icons, web pages, images, web page links, etc.) that are displayed through the display 132. The client device 104 may further include one or more input/output (I/O) devices 138 (e.g., a keypad, buttons, a wireless input device, a thumbwheel input device, a trackstick input device, and so on). The I/O devices 138 may include one or more audio I/O devices, such as a microphone, speakers, and so on. Thus, I/O devices 138 may include a keyboard configured to receive user input. In an implementation, the keyboard may be integrated with the client device 104, or the keyboard may be a peripheral device that is configured to interface with the device 104 (e.g., via a USB port, etc.).

The client device 104 is illustrated as including a user interface 142, which is storable in memory 122 and executable by the processor 118. The user interface 142 is representative of functionality to control the display of information and data to the user of the client device 104 via the display 132. In some implementations, the display 132 may not be integrated into the mobile electronic device and may instead be connected externally using universal serial bus (USB), Ethernet, serial connections, and so forth. The user interface 142 may provide functionality to allow the user to interact with one or more applications 144 of the client device 104 by providing inputs via the touch panel 134 and/or the I/O devices 138. For example, the user interface 142 may cause an application programming interface (API) to be generated to furnish functionality to an application 144 to configure the application for display by the display 132 or in combination with another display. In embodiments, the API may further furnish functionality to configure the application 144 to allow the user to interact with an application by providing inputs via the touch panel 134 and/or the I/O devices 138.

Applications 144 may comprise software, which is storable in memory 122 and executable by the processor 118, to perform a specific operation or group of operations to furnish specified functionality to the client device 104.

As shown, the computing device 102 and/or the client device 104 may be in communication with one or more image capture devices 146. The image capture devices 146 comprise devices (e.g., cameras) for capturing images and/or videos. For instance, the image capture devices 146 may be configured to capture anatomic and/or clinical laboratory specimens and provide image data representing the captured imagery to the computing device 102 and/or the client device 104. In one or more implementations, the image capture device 146 is configured to generate image including one or more spectral characteristics of the anatomic and/or clinical laboratory specimens. In one or more implementations, the image capture device 146 is configured to generate image including one or more hue characteristics of the anatomic and/or clinical laboratory specimens.

As shown in FIG. 1A, the server 102 includes a quality measurement module 148 that is storable in the memory 120 and executable by the processor 116. The quality measurement module 148 is representative of functionality to generate a quantitative metric based upon one or more selected quality metrics corresponding to an anatomic pathology tissue sample. For example, as described in greater detail below, the server 102 receives the quality metrics from one or more client devices 104. In response, the quality measurement module 148 generates a quantitative metric corresponding to the quality metrics.

In one or more implementations, the system 100 may comprise a Health Insurance Portability and Accountability Act (HIPPA) compliant cloud-based computer architecture for managing and measuring external quality assurance review. Initially, a pathology practice (e.g., a pathology professional, a group of pathology professionals) identifies and selects a case (e.g., an anatomic pathology tissue sample) for quality assurance review based on defined criteria and published recommendations of The Association of Directors of Anatomic and Surgical Pathology (ADASP). These recommendations take into consideration the structure, responsibilities, and needs of academic anatomic pathology laboratories that have an active residency or fellowship. These recommendations can be modified according to specific institutional circumstances and needs.

Depending on departmental resources, a number of methods may serve as quality assurance case reviews including; review of a randomly selected percent of cases (e.g., 1%, 2%, 5%, 10% depending on the size of practice and available staff time to conduct reviews).

In one embodiment, a minimum of twenty cases per pathologist can be submitted to ensure statistical significance is maintained for quantitative analysis and comparison benchmarking. Objective data relative to the case (e.g., data representing imagery of the anatomic pathology sample captured by the image capture devices 146, data representing turn-around-time related to the anatomic pathology sample, data representing a diagnosis related to the anatomic pathology sample) is aggregated, collated, and converted in digital format as an e-case for upload via a secure network (e.g., network 106) to the server 102 via a client device 104.

Once the upload of the data corresponding to the case is completed, a quality assurance analysis is performed by the server 102. For example, the server 102 automatically applies a digital slide analysis to the image data representing the anatomic pathology sample to assess image attributes and the completeness of the objective data submission as described in greater detail below. If the quality of the digital slide is insufficient, a visual qualitative assessment is performed to provide an objective measure or score for quality. The associated scores are: 1=Good; 2=Adequate, and 3=Unacceptable. If the digital slide (e.g., image data of the anatomic pathology specimen) is rejected, the anatomic pathology practice can prepare a new glass slide, reimage the sample within the glass slide, and resubmit the data representing the updated imagery via the client device 104.

In another implementation, as shown in FIG. 1A, the sever 102 is communicatively connected to a staining device 149. The staining device 149 comprises a device that can apply a stain to the specimen. For example, the staining device 149 can apply a variety of staining compounds (e.g., stain) to the specimen. For instance, the staining compounds can comprise biological stains such as antibodies or chemical stains including dyes and pigments. The staining device 149 includes a staining head 151 that can be positioned proximate to the specimen. Once the staining head 151 is positioned proximate to the specimen, the staining head 151 can disperse the stain. In some implementations, the image capture device 146 is integral with the staining device 149. In other implementations, the staining device 149 and the image capture device 149 are discrete devices.

As shown in FIG. 1A, the server 102 includes an image analysis module 150, which is storable in the memory 120 and executable by the processor 116. The image analysis module 150 is representative of functionality for identifying tumor tissue(s) based upon the provided image data. In an implementation of the present disclosure, if the digital slide is of insufficient quality, the module 150 transmits a request to the client device 104 over the network 106. The request can automatically cause the user interface 142 of the client device 104 to display a graphical interface requesting submission of a new digital slide. If the quality of the slide image is sufficient for quality review, then the digital slide can be analyzed and interpreted by the reviewing pathologist.

As described above, the image analysis module 150 provides functionality to identify one or more pixels as corresponding to a tumor tissue. For instance, the processor 116 can compare pixels of the digital image representing the specimen to one or more pixels (e.g., adjacent pixels) of the digital image to compare one or more characteristics of the pixels. In an implementation, the processor 116 iterates through the digital image comparing pixel characteristics. Based upon one or more pixel characteristics, the processor 116 can identify (e.g., determine) a region of interest that may correspond to tumor tissue. The image analysis module 150 retains information to cause the processor 116 to identify regions of interest within the digital image of the specimen. In implementations, the processor 116 is configured to identify regions of interest based upon an identifying characteristic (e.g., the pixels having a hue characteristic corresponding to purple). Thus, the processor 116 iterates through the digital image to identify regions of interest where pixels within that region of interest have characteristics corresponding to the identifying characteristic. For instance, the hue (color) characteristics of the pixels within the region of interest may differ from the hue characteristics of pixels not within the region of interest. For instance, the hue (color) characteristics of the pixels within the region of interest are purple (due to staining of the specimen), and the hue characteristics of the pixels outside the region of interest differ substantially (e.g., the hue characteristics correspond to pink, etc.). Thus, the pixels having characteristics that at least substantially match the identifying characteristic are deemed to be within the region of interest. As described above, the pixels within the region of interest may be indicative of tumor tissue within the specimen.

Upon determining, a region of interest within the digital image, the image analysis module 150 provides functionality to determine an image quality of the digital image of the specimen. In one or more implementations, one or more baseline characteristics may be stored in the database 152. In an implementation, the baseline characteristics may comprise baseline digital images having regions of interest. The baseline digital images comprise digital images having baseline pixel characteristics (e.g., the baseline pixel characteristics of the regions of interest). In another implementation, the baseline characteristics may comprise baseline data corresponding to pixel characteristics. For instance, the baseline characteristics may comprise hue characteristics indicating an acceptable image quality (e.g., the pixels indicative of tumor tissue are sufficiently purple). For example, the baseline digital images may represent specimens having tumors therein, and the regions of interest correspond to the tumors.

The image analysis module 150 provides functionality to compare a characteristic of at least one pixel within the identified region of interest the baseline characteristics to determine whether the pixels within the identified region are above a threshold. Pixels within identified region having characteristics at or exceeding the threshold may comprise pixels indicative of sufficient image quality. In an implementation, the threshold may comprise a value indicative of a suitable hue characteristic. For example, the processor 116 determines whether a hue characteristic of a pixel within the identified region is equal to or exceeds the baseline characteristics. Thus, the processor 116 can compare a hue characteristic of the digital image provided by the client device 104 to a similar hue characteristic of the baseline digital image to determine the image quality of the digital image. In response, the processor 116 determines whether the image quality of the digital image is sufficient. In some instances, the processor 116 generates a score corresponding to the difference in the hue characteristics between the pixel within the identified region and the baseline characteristics (e.g., the hue characteristics of the digital image is within ten percent (10%) of the hue characteristics of the baseline characteristics). Digital images of insufficient quality may comprise pixels having hue characteristics that are less than the hue characteristics of the baseline image (e.g., the pixels are “less” purple with respect to the baseline characteristics), which may be indicative of insufficient stain applied to the specimen.

In instances where the server 102 deems the digital image to be of insufficient quality (e.g., pixels within the identified region of interest have characteristics below the quality threshold), the server 102 can cause the staining device 149 to re-apply stain to the specimen. For instance, the server 102 may cause the staining device 149 to re-apply the stain in real-time or near real-time (e.g., causing re-application of the stain upon determining an image of insufficient quality). Once the stain has been re-applied to the specimen, the server 102 causes the image capture device 146 to capture another digital image of the specimen in real-time or near real-time. Thus, the server 102 can transmit a signal causing the staining device 149 to re-apply the stain and causing the image capture device 146 to capture another digital image of the specimen when the server 102 determines that the original digital image is not of sufficient quality. In some instances, the server 102 can cause re-orientation of the staining device and/or the image capture device 146 (e.g., the server 102 is operably coupled to at least one of a mechanical component of the image capture device 146 or an electro-mechanical component of the image capture device 146). For instance, the server 102 can issue commands over the network 106 to cause the image capture device 146 to adjust an angle of incidence with respect to the specimen (e.g., cause the image capture device 146 to re-orient itself with respect to the specimen to alter the angle of incidence). In some implementations, the server 102 can cause the image capture device 146 to adjust a magnification characteristic of the image capture device 146. For instance, if the image quality of the digital image is determined to be insufficient, the server 102 can issue one or more commands to cause the image capture device 146 to adjust a magnification characteristic (e.g., a higher magnification characteristic, a lower magnification characteristic, etc.) compared to the magnification characteristic of the original digital image. This process may continue until the server 102 determines that the digital image is of sufficient quality.

Once a digital image of sufficient quality has been provided, the image analysis module 150 applies qualitative and quantitative image analysis (Q2IA) and enhancement to measure the quality of the digital slide (e.g., the digital image of the anatomic pathology specimen, the image data representing the anatomic pathology specimen). For example, the colors of stains can be enhanced by the module 150 or even changed to provide more color contrast in counterstained samples. In an implementation, the quality analysis module 150 comprises a suitable image analysis module (e.g., a TissueMark® image analysis tool, or the like) that generates a quantitative visualization of tumor probability for regions within the marked-up boundary. Regions of high tumor probability may be labeled red and regions of low tumor probability may be labeled pale blue/transparent. This quantitative visualiziation allows highlighting areas of non-tumour such as stroma, inflammation, and necrosis that are included within the macrodissection boundary. After the quality is determined and image analysis of the digital image (e.g., image data) is performed, the digital slide can then be analyzed and interpreted by a reviewer (e.g., by a sub-specialty expert pathologist) who views the digital slide at the user interface at a client device 104 communicatively connected to the server 102.

Furthermore, the reviewing expert pathologist analyzes and interprets the digital slide for diagnostic accuracy compared to the original subjective interpretation rendered by the submitting pathologist. An expert interpretation is recorded from the reviewing subspecialist via a client device 104 and stored as a reviewer quality data management data input (e.g., a metric as described in greater detail below) within a database 152 of the server 102 for further processing by the module 148. For instance, the reviewing pathologist transmits an assessment of an image attribute of the specimen. The attribute (e.g., assessment metric), for example, may comprise indications of cancer, disease, or the like. The assessment may comprise a diagnostic accuracy review measured as one of the standard and/or acceptable values. For instance, the assessment (e.g., feedback, etc.) may comprise: (1) Concordant: Preferred diagnosis is substantially identical with the target diagnosis; (2) Concordant with Comments: Would like to add a comment or provide some constructive feedback to the case; (3) Minor Discordant: Disagreement not clinically relevant; (4) Discordant: Disagreement, clinically relevant, but does not change the original diagnosis; and (5) Major Discordance: Disagreement that may result in a change in the initial diagnostic report and impact patient care.

In another implementation, the server 102 includes an image determination module 153 that is stored in the memory 120 and executable by the processor 116. The image determination module 153 represents functionality for determining an image attribute of the digital image. The database 152 retains multiple digital images (e.g., a library of digital images) representing already completed cases. For example, these digital images may comprise images of a specimen where a final determination (e.g., previously analyzed) has been made regarding the specimen (e.g., cancer, disease, etc.). The database 152 can retain associated information with each digital image indicting the final determination (e.g., reference digital images). For example, the reference digital images include metadata associated therewith such that the metadata provides the final determination. The image determination module 153 can cause the processor 116 to determine an image attribute of the current digital image based upon a comparison with one or more reference digital images. For instance, as described above, the processor 116 identifies a region of interest. The processor 116 can compare the characteristics of the pixel within the identified region with characteristics of corresponding pixels within a region of interest in the reference digital images. For example, the captured digital image comprises an image representing a specimen having a tumor therein. The processor 116 identifies a subset of pixels as representing the tumor (e.g., the region of interest) based upon the characteristics of the pixels representing the tumor with respect to the characteristics of the pixels representing the remaining portion of the specimen. The processor 116 then compares at least one pixel characteristic of a pixel within the identified region with a pixel characteristic of a pixel of at least one reference digital image. In some implementations, the processor 116 compares the pixel characteristic with a pixel characteristic of a pixel within an identified region of a group of reference digital images. For example, the processor 116 compares the pixel characteristic with a pixel characteristic of a pixel within an identified region of each reference digital image. In some implementations, the processor 116 (e.g., server 102) can cause the image capture device 146 to adjust a magnification characteristic such that the image capture device 146 generates a digital image corresponding to the region of interest with the magnification characteristic. For example, once the region of interest is identified within a first digital image, the processor 116 causes the image capture device 146 to capture and generate a second digital image of the specimen having a different magnification characteristic with respect to the first digital image. For instance, the second digital image may have a higher magnification characteristic of the region of interest compared with the first digital image.

In some implementations, a spectral analysis may be applied to the digital image. For instance, the processor 116 may select one or more pixels within the identified region and apply a Fast Fourier transform to these pixels to generate a spectral representation of the pixels. In the implementation described above, the processor 116 can generate a spectral representation corresponding to the tumor.

Based upon this comparison, the processor 116 determines an image attribute of the identified region. For example, based upon the comparison, the processor 116 determines whether the pixel within the identified region comprises cancer, disease, or the like. The processor 116 can then compare the determined image attribute with the image attribute provided by the client device 104 and provide a metric associated therewith. In an implementation, the processor 116 generates an assessment metric based upon the comparison of the processor determined image attribute and an image attribute provided by the client device 104. For instance, the image attribute provided by the client device 104 may comprise data representing a decision by a pathologist regarding the specimen (e.g., cancer, disease, etc.). Thus, the processor 116 compares the processor 116 generated image attribute with an attribute of the specimen provided by the client device 104. For example, if the determined image attribute matches the provided image attribute, the processor 116 generates an assessment metric indicating that the determined image attribute and the provided image attribute are concordant. If the determined image attribute does not match the provided image attribute, the processor 116 generates an assessment metric indicating discordant or major discordance.

Diagnostic Confidence indicates whether the case had a second review prior to sign-out which may have been a formal consult or an informal review. Results of the consult or review can be found in the case notes. In implementations, the server 102 receives data from the client device 104 corresponding to Diagnostic Confidence. For instance, the server 102 can be provided data corresponding to the instant case that includes information of whether, prior to sign-out, the case had a second review. Based upon this data, the server 102 generates a metric representing a Diagnostic Confidence. For instance, the metric may represent a score of one (1) indicating a second review of the case did occur or zero (0) indicating a second review of the case did not occur. In some instances, based upon previous submissions of the pathologist, the server 104 can apply confidence interval ranking to the Diagnostic Confidence metric. In these implementations, the database 152 maintains previous submissions provided by the pathologists such that the processor 116 can compare currently submitted data against previously submitted data and previously generated metrics and/or scores. For instance, in the event this pathologist has submitted cases having a second review but the second review was discordant, the processor 116 can generate a metric that is lower that a metric where the pathologist has submitted cases having a second review and the second review was concordant with the initial diagnosis. Thus, the processor 116 can generate a confidence interval related to these metrics and apply the confidence interval to any newly generated Diagnostic Confidence metrics.

Clerical Accuracy, may include, but is not limited, to accurate tracking of the specimen from collection to analysis ensuring no mix-up of the specimen occurs. Thus, the client device 104 can provide the server 102 with data representing a log that represents tracking of the specimen from collection to analysis. Additionally, clerical accuracy may also include accurately recording the diagnosis from the specimen into the appropriate file. Based upon this information, the server 102 is configured to generate a Clerical Accuracy parameter (e.g., metric) indicating whether The Clerical Accuracy parameter (e.g., parameter representing the clerical accuracy) is recorded in the database 152 as: (1) Concordant: Preferred diagnosis is substantially identical with the target diagnosis; (2) Concordant with Comments: Would like to add a comment or provide constructive feedback to the clerical component of the case; (3) Minor Discordant: Clerical Inaccuracy not clinically relevant; (4) Discordant: Clerical inaccuracy, clinically relevant, but does not change the diagnosis; or (5) Major Discordant: Clerical inaccuracy that may result in a change in the initial diagnostic report. For instance, the processor 116 generates a Clerical Accuracy metric based upon data within the log and/or information provided by the client device 104. In some implementations, the processor 116 identifies whether the specimen was accurately recorded at each transaction point within the collection to analysis chain (e.g., whether specimen was recorded at collection, whether specimen was recorded at imaging, whether specimen was recorded at analysis, etc.). Thus, the log can contain data corresponding to each recordation (e.g., check-in) at each transaction point within the chain. If the server 102 determines that the specimen was properly recorded at each transaction point, the server 102 generates a first metric, and if the server 102 determines that the specimen was not properly recorded at each transaction point, the server 102 generates a second metric that is lower than the first metric.

Furthermore, Turn around Time (TAT) is based on a computer-generated time from the case accession time and the pathology case sign out time. In some instances, the time may be measured in seconds, minutes, or hours. Turn around time may include case accession, the time the specimen is collected to pathology case sign out time, and/or the time the submitting pathologist provides a diagnosis. As an absolute value, TAT is normalized by grouping in reports of laboratories with similar service hours and case complexity. In one or more implementations, the server 102 generates a TAT metric by measuring one or more time characteristics associated with the case. As described above, the client device 104 provides a log corresponding to the case. The log can contain data representing a time characteristic associated with each portion of the case. Thus, the client device 104 can measure and record one or more time characteristics corresponding to case accession time to sign out time. The processor 116 is configured to generate a Turn around time metric based upon the recorded time characteristics.

In one embodiment, the quality measurement module 148 aggregates the automated assessment and objective assessment (e.g., input data) provided by the reviewer of the case comparatively against a predefined set of criteria. The module 148 provides functionality that can support the pathologist through a clinical decision support function that guides the pathologist through the process of making an interpretation or opinion in order to arrive at a concordance or discordance for the slide (e.g., image data representing the anatomic pathology specimen) and overall case.

In one embodiment of FIG. 1A, quality assurance module 148 generates a unique Professional Practice Score (PPS) utilized to benchmark quality performance in pathology and for medical practice continuous improvement. The PPS score comprises five (5) quality metrics that have a role in reducing diagnostic error. For example, one or more of the metrics may comprise confidence levels, diagnostic accuracy, image attribute, applied time, and completeness of information (e.g., whether required data for a case has been completed by the pathology practice or received at the server 102).

In one or more implementations, the server 102 is communicatively connected with the client devices 104. The client devices 104, in part, serve to provide access to the quality measurement module 148 for the subspecialist reviewing pathologist such that the subspecialist reviewing pathologist can upload the input data representing one or more of the quality metrics. Thus, the server 102 can provide functionality to: (1) Host case data information and digital slide images; (2) Serve as an application host site for subspecialist to complete the case review; (3) Generate the graphical representations and provide clinical alerts for Major Discordant Reviews; and (4) Create observational data storage for future data mining and longitudinal analytics. Additionally, as described above, the quality measurement module 148 accesses the metrics generated by the server 102 as described above.

With regards to metrics having Major Discordant Reviews from the reviewing pathologist, the quality measurement module 148 can automatically generate an alert 200 (see FIG. 1B) indicating that a Major Discordant Review has been received for the respective metric and automatically issue the alert to the appropriate client device 104. The client device 104, upon receiving the alert 200, can automatically generate a window 202 at an unobscured portion 204 (e.g., information within the window 202 is viewable to the end user) of the display 132 such that an end user can be notified of the Major Discordant Review and employ necessary steps to remedy the situation for the patient. In an implementation, the alert may comprise textual information 206 regarding the Major Discordant Review and relevant identifying information regarding the case.

In one embodiment, the quality measurement module 148 applies a process for weighting of clinical concordance or discordance for both the submitting pathologist input of objective numeric and clerical values and subspecialist reviewer contribution of interpretation values of concordance and discordance to calculate and generate a Practice Proficiency Score. Discordance is applied through a weighted value based on a risk factor of contribution to clinical discordance and effect on patient care. A grading scheme is applied by the quality measurement module 148 that assigns a discrete value relative to what harm or potential harm may result from the interpretive error. Consideration can be given to communicating to risk management any error that has significant harm or impact on patient care. For example, the grading scale may comprise: No harm or impact on patient care (Labeled as “Minor Discordance”) and grade=3; slight harm or impact on patient care (Labeled as “Discordance”) and grade=5; and significant harm or alteration of clinical management (Labeled as “Major Discordance”) and grade=10. The Practice Proficiency Score comprises the normalized weighted mean of the five (5) quality metrics identified above. The Practice Proficiency Score can be determined as follows:

x̅=Σᵢ₌₁ⁿwᵢxᵢ EQN. 1

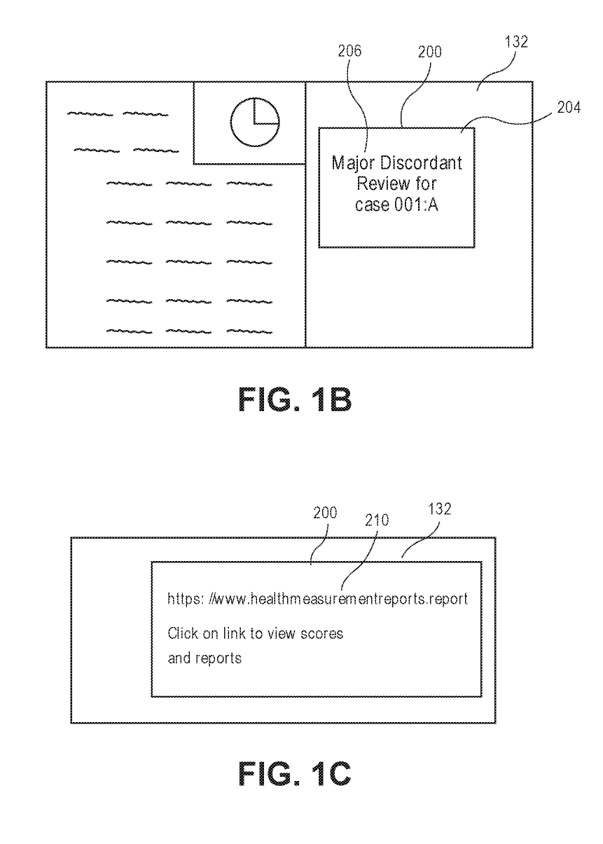

By detecting and analyzing variability in the Practice Proficiency Score, health care providers can access pathologist proficiency and guide continuous improvement initiatives to reduce diagnostic discordance. The Practice Proficiency Score is uniquely applied to the pathologist and/or laboratory under review by plotting the Practice Proficiency Score in a benchmark funnel graph against a uniquely created experience curve based upon years of experience and monthly caseload by tissue type (see FIG. 2).

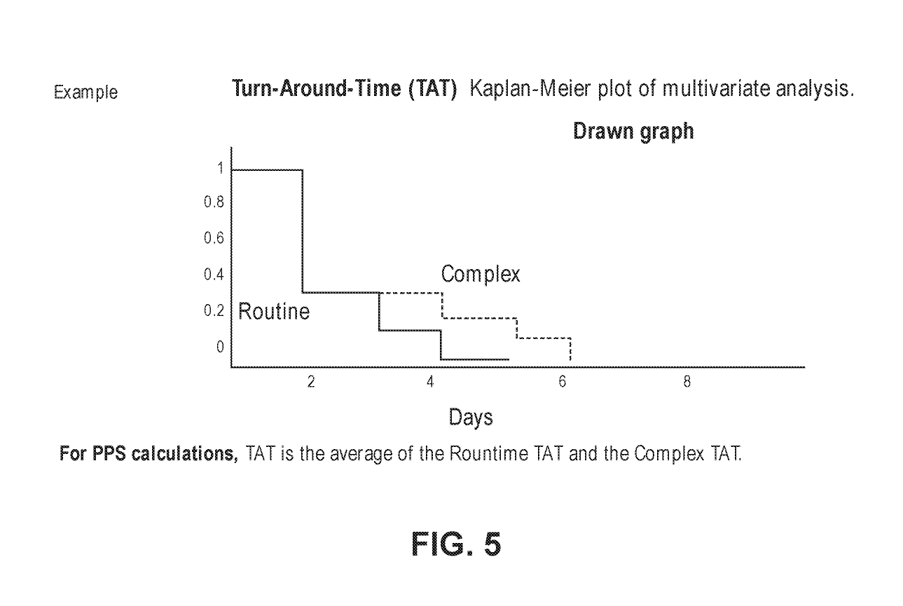

Once the Practice Proficiency Score has been generated by the module 148, the module 148 can transmit an alert 200 to the corresponding pathologist(s) (e.g., the pathologist(s) corresponding to the case). In one or more implementations, as shown in FIG. 1C, the alert 200 comprises a Uniform Resource Locator (URL) link 210 that provides access to the Practice Proficiency Score and one or more reports (as described below and shown in FIGS. 2 through 5) that reside on the server 102. Once the respective pathologist interfaces with the URL link 210, the URL link 210 causes display of the one or more reports corresponding to the Practice Proficiency Score at the display 132 of the client device 104. In some implementations, once the client device 104 has communicatively connected to the server 102 via the network (e.g., establishes a communication link, etc.), the module 148 may automatically cause one or more reports corresponding to the Practice Proficiency Score to be displayed at the display 132 (e.g., user interface 142) of the client device 104.

The quality measurement module 148 can also be representative of generating and providing reports and constructive feedback to the pathologist and/or pathology group. The reports corresponding to the anatomic pathology specimen are generated based on pre-defined criteria and/or can be created ad-hoc based on queries generated by the end user through the user interface 142 of the client device 104. In some implementations, the quality measurement module 148 automatically generates a report in response to a request from the client device 104. In some instances, the report is based upon pre-defined parameters set forth in a user profile 154. For instance, a user profile 154 may be retained at the client device 104, and the user profile 154 may store one or more parameters defining reporting criteria for report generation. This user profile 154 may also be stored in the server 102. In some embodiments, each time the client device 104 interfaces the server 102, the quality measurement module 148 determines whether any updates have been made to parameters set forth in the user profile 154. If so, the quality measurement module 148 automatically updates the corresponding parameters in the user profile 154 stored in the server 102. In other embodiments, the quality measurement module 148 generates reports dynamically (e.g., ad-hoc) based upon one or more requests from an end user. For instance, an end user may generate a first request for a first report by submitting the first request through a client device 104 to the server 102. In response, the module 148 generates a report based upon the first request (e.g., according to the parameters set forth in the first request). In another instance, an end user (e.g., a different end user or the same end user) may generate a second request for a second report by submitting the second request through a client device 104 to the server 102. In response, the module 148 generates a report based upon the second request (e.g., according to the parameters set forth in the second request).

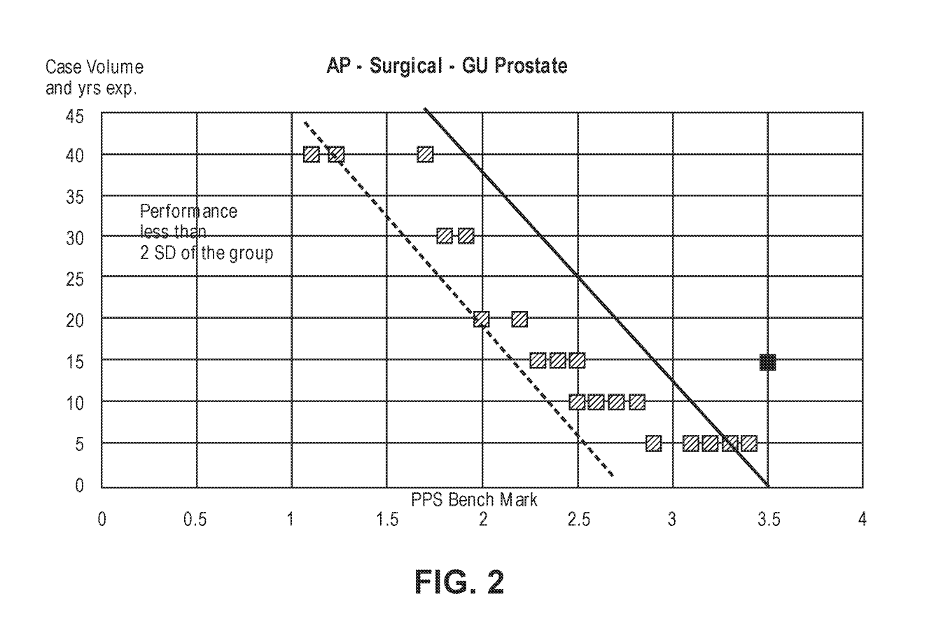

In an embodiment, the quality measurement module 148 generates one or more visual representations of the Practice Proficiency Score. In some embodiments, the reports may, in part, comprise the visual representations of the Practice Proficiency Score. For instance, the module 148 can generate a multivariate graph of case review metrics and individual assessment metrics corresponding to the Practice Proficiency Score, which can be stored longitudinally for qualitative and comparative analysis (see FIG. 3). The visual representations may comprise a graphical method of displaying multivariate data, metrics, in the form of a two-dimensional chart of three or more quantitative variables represented on axes starting from the same point. The star graph displays the performance metrics of the ongoing quality assurance program. At a glance, the pathologist member can interpret the following information based on plus or minus two (2) standard deviations (+/−2 SD) from the norm of the group: diagnostic accuracy, clerical error, case complexity, diagnostic confidence, and image attributes which are relative to their risk adjusted peer group.

The server 102 includes a benchmarking module 156, which is stored in the memory 120 and executable by the processor 116. The benchmarking module 156 provides a comparative analysis of the Practice Proficiency Score of one Pathologist or laboratory with corresponding (e.g., “best match”) peers of the same category, experience level, and specialty. A Pathologist's mean Practice Proficiency Score is determined and compared to the peer group, +/−2 SD, using a Stock Graph or Pathologist's Resume. The Resume provides longitudinal comparison by specialty peer group.

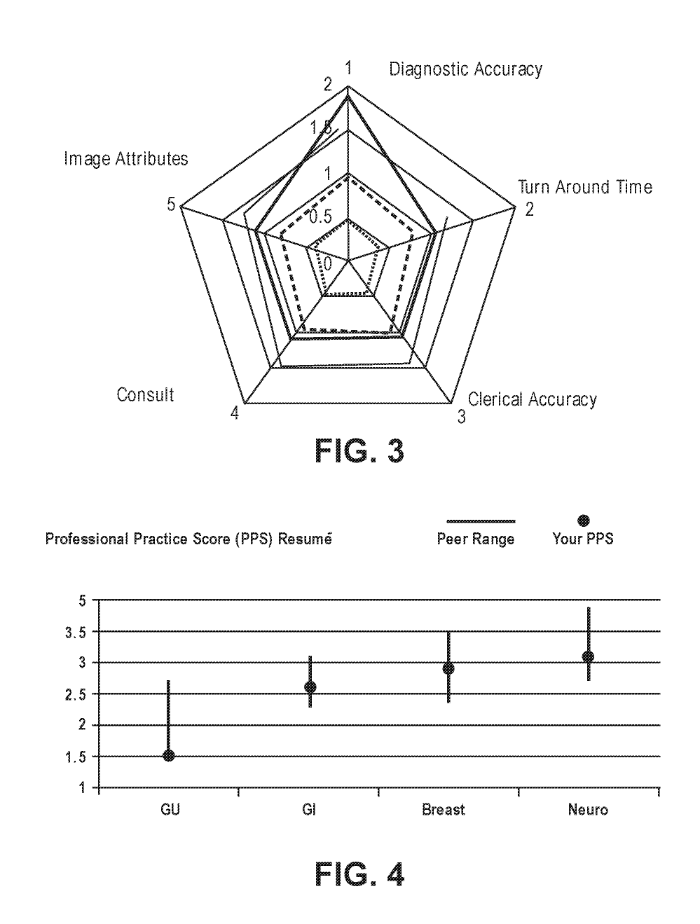

Furthermore, as shown in FIG. 4, the comparative analysis generated by the benchmarking module 156 is applied to turn around time (TAT) versus case complexity. This is a Kaplan-Meier plot of multivariate analysis based on case complexity and Turn around-Time. Case complexity, for example, relates to the type of specimen analyzed. Case complexity is determined by the highest assigned CPT code and broken out in the following manner: Qualifiers for comparatives are based on five (5) day or seven (7) day laboratory operations. Additional variables are applied to calculate case complexity, which may include immunohistochemical (IHC) stains and molecular tests. Bone decalcification cases are omitted as qualifiers for complexity. The case is calculated using the site TAT times for all cases submitted, regardless if the site is made up of a single pathologist or a group of pathologists.

In one or more implementations, the benchmarking module 156 provides benchmarking for pathologist and or group Practice Proficiency Score at six (6) month intervals. On a six-month basis, longitudinal quality assurance reports demonstrate changes in the PPS of the individual practitioners total cases submitted, which allows an objective performance evaluation over time. Pathologists can track their performance levels on a timelier basis, and support the institution's efforts in creating an evidence-based process for credentialing. Interpretation based on longitudinal Practice Proficiency Score for each member Practice Proficiency Score is displayed graphically over time, and a trend line is generated. Pathologists can review the graph to evaluate which area had the greatest effect on the change of their longitudinal performance. The mean of the peer group, and the individual axes are adjusted to generate a symmetrical square for ease of interpretation.

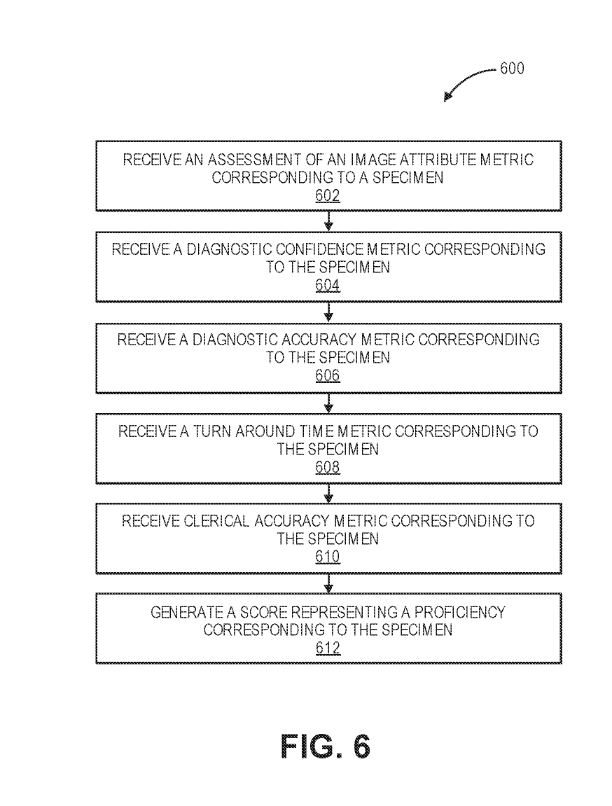

FIG. 6 illustrates an example method 600 for generating a Practice Proficiency Score corresponding to a specimen in accordance with an example implementation of the present disclosure. The Professional Practice Score is generated based upon the metrics described herein. As described above, each metric measures an objective aspect of a case corresponding to a specimen based upon the pathologist submitting the case. As discussed above, the specimen may comprise an anatomic pathology specimen, a histologic specimen, a clinical specimen, a blood film, a microbiology specimen, or the like. As shown in FIG. 6, the method 600 includes receiving an assessment of an image attribute metric of a digital image of a specimen (Block 602). For example, data representing a digital image and/or data representing an assessment relating to an image attribute of the digital image is received at a server 102 from a client device 104 over a network 106. In an implementation, the data representing the digital image is generated by an image capture device 146. As discussed above, an assessment related to (e.g., pertaining to, corresponding to) the digital image is provided to the server 102. The assessment may comprise a diagnosis pertaining to the specimen. The quality measurement module 148 may utilize this assessment, as described above, to determine a Professional Practice Score relating to the specimen. Additionally, as described above, the server 102 determines an assessment relating to the image attribute. For instance, the server 102 can compare image characteristics of the digital image to one or more baseline image characteristics of baseline image characteristics.

As shown in FIG. 6, a diagnostic confidence metric corresponding to the specimen is received (Block 604). In one or more implementations, a diagnostic confidence relating to the specimen is received at the server 102. Diagnostic confidence comprises data indicating whether the case had a second review prior to sign-out which may have been a formal consult or an informal review.

A diagnostic accuracy metric corresponding to the specimen is received (Block 606). In one or more implementations, diagnostic accuracy comprises data representing an interpretation by a reviewing pathologist of information regarding the case (e.g., the specimen). For instance, the reviewing pathologist may provide a diagnostic accuracy that comprises (1) Concordant: Preferred diagnosis is substantially identical with the target diagnosis; (2) Concordant with Comments: Would like to add a comment or provide some constructive feedback to the case; (3) Minor Discordant: Disagreement not clinically relevant; (4) Discordant: Disagreement, clinically relevant, but does not change the original diagnosis; and (5) Major Discordance: Disagreement that may result in a change in the initial diagnostic report and impact patient care.

As shown in FIG. 6, a turn around time metric corresponding to the specimen is received (Block 608). As discussed above, the turn around time comprises the time from the case accession time and the pathology case sign out time and is received at the server 102 from the client device 104. As described above, the server 102 and/or the client device 104 are configured to measure the turn around time. A clerical accuracy metric corresponding to the specimen is received (Block 610). In one or more implementations, the clerical accuracy comprises accurate tracking of the anatomic pathology specimen from collection to analysis ensuring no mix-up of the specimen occurs. Additionally, clerical accuracy may also include accurately recording the diagnosis from the specimen into the appropriate file. Clerical Accuracy parameters are recorded and stored in the database 152 by the reviewing subspecialist (e.g., reviewing pathologist). Additionally, the server 102 is configured to iterate through information pertaining to the specific case and determine a clerical accuracy based upon one or more defined characteristics within the information.

A score representing a proficiency corresponding to the specimen is generated (Block 612). In one or more implementations, the quality measurement module 148 generates a score that represents a proficiency corresponding to the specimen. As described above, the score comprises a Professional Practice Score that measures a proficiency of a pathologist (or pathologist group) with respect to a similar pathologist (or similar pathologist groups), and the score is based upon the metrics described above. In some implementations, the quality measurement module 148, once a client device 104 of a respective pathologist communicatively connects with the server, automatically causes display of information including a Uniform Resource Locator (URL) that provides access to the Practice Proficiency Score and one or more reports representing a graphical visualization of the Practice Proficiency Score.

Generally, any of the functions described herein can be implemented using hardware (e.g., fixed logic circuitry such as integrated circuits), software, firmware, or a combination of these embodiments. Thus, the blocks discussed in the above disclosure generally represent hardware (e.g., fixed logic circuitry such as integrated circuits), software, firmware, or a combination thereof. In the instance of a hardware embodiment, for instance, the various blocks discussed in the above disclosure may be implemented as integrated circuits along with other functionality. Such integrated circuits may include all of the functions of a given block, system or circuit, or a portion of the functions of the block, system or circuit. Further, elements of the blocks, systems or circuits may be implemented across multiple integrated circuits. Such integrated circuits may comprise various integrated circuits including, but not necessarily limited to: a monolithic integrated circuit, a flip chip integrated circuit, a multichip module integrated circuit, and/or a mixed signal integrated circuit. In the instance of a software embodiment, for instance, the various blocks discussed in the above disclosure represent executable instructions (e.g., program code) that perform specified tasks when executed on a processor. These executable instructions can be stored in one or more tangible computer readable media. In some such instances, the entire system, block or circuit may be implemented using its software or firmware equivalent. In other instances, one part of a given system, block, or circuit may be implemented in software or firmware, while other parts are implemented in hardware.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
determining, via a processor, a first image attribute of a digital image of a specimen based upon at least one pixel characteristic of the digital image, the digital image captured by an image capture device;
generating an assessment metric based upon a comparison of the first image attribute with a second image attribute provided by a client device;
receiving a diagnostic confidence metric corresponding to the specimen, the diagnostic confidence metric comprising an indication of whether a second review of the specimen occurred;
receiving a diagnostic accuracy metric corresponding to the specimen, the diagnostic accuracy metric comprising an accuracy indication of a diagnosis of the anatomic pathology specimen;
receiving a turn around time metric corresponding to the specimen, the turn around time metric comprising a time ranging from a case accession time to a case sign out time;
receiving a clerical accuracy metric corresponding to the specimen, the clerical accuracy metric comprising a clerical accuracy parameter pertaining to the specimen; and
causing the processor to generate a score representing a proficiency corresponding to the specimen, the score based upon the assessment metric, the diagnostic confidence metric, the diagnostic accuracy metric, the turn around time metric, and the clerical accuracy metric.

2. The method as recited in claim 1, further comprising determining, via a processor, an image quality of the digital image; causing the image capture device to generate a second digital image of the specimen when the image quality is below a threshold.

3. The method as recited in claim 2, further comprising causing a staining device to apply a stain to the specimen when the image quality is below the threshold.

4. The method as recited in claim 2, wherein determining the image quality further comprises identifying a region of interest of the specimen within the digital image; and comparing an image characteristics of the region of interest with an image characteristic of the baseline region of interest within a baseline digital image.

5. The method as recited in claim 4, further comprising comparing a hue characteristic of a pixel within the region of interest with a hue characteristic of a pixel within the baseline region of interest.

6. The method as recited in claim 1, further comprising causing the processor to generate an alert; causing transmission of the alert to a client device, the alert comprising a Uniform Resource Locator link providing access to the score.

7. The method as recited in claim 1, wherein the specimen comprises at least one of an anatomic pathology specimen or a clinical laboratory specimen.

8. A computing device comprising:
a memory operable to store one or more modules; and
a processor communicatively coupled to the memory and operatively coupled to an image capture device, the processor operable to execute the one or more modules to:
determine a first image attribute of a digital image of a specimen based upon at least one pixel characteristic of the digital image, the digital image captured by an image capture device;
generate an assessment metric based upon a comparison of the first image attribute with a second image attribute provided by a client device;
receive a diagnostic confidence metric corresponding to the specimen, the diagnostic confidence metric comprising an indication of whether a second review of the specimen occurred;
receive a diagnostic accuracy metric corresponding to the specimen, the diagnostic accuracy metric comprising an accuracy indication of a diagnosis of the anatomic pathology specimen;
receive a turn around time metric corresponding to the specimen, the turn around time metric comprising a time ranging from a case accession time to a case sign out time;
receive a clerical accuracy metric corresponding to the specimen, the clerical accuracy metric comprising a clerical accuracy parameter pertaining to the specimen; and
generate a score representing a proficiency corresponding to the specimen, the score based upon the assessment metric, the diagnostic confidence metric, the diagnostic accuracy metric, the turn around time metric, and the clerical accuracy metric.

9. The computing device as recited in claim 8, wherein the processor is further operable to execute the one or more modules to determine an image quality of the digital image and causes the image capture device to generate a second digital image of the specimen when the image quality is below a threshold.

10. The computing device as recited in claim 9, wherein the processor is operably coupled to a staining device, the processor further operable to execute the one or more modules to cause the staining device to apply a stain to the specimen when the image quality is below the threshold.

11. The computing device as recited in claim 9, wherein the processor is further operable to execute the one or more modules to identify a region of interest of the specimen within the digital image; and compare an image characteristics of the region of interest with an image characteristic of the baseline region of interest within a baseline digital image.

12. The computing device as recited in claim 9, wherein the processor is further operable to execute the one or more modules to compare a hue characteristic of a pixel within the region of interest with a hue characteristic of a pixel within the baseline region of interest.

13. The computing device as recited in claim 8, wherein the processor is further operable to execute the one or more modules to generate an alert and cause transmission of the alert to a client device, the alert comprising a Uniform Resource Locator link providing access to the score.

14. The computing device as recited in claim 8, wherein the specimen comprises at least one of an anatomic pathology specimen or a clinical laboratory specimen.

15. A system comprising:
an image capture device;
a client device;
a server configured to communicatively connect to the client device and operatively coupled to the image capture device over a network, the server comprising:
a memory operable to store one or more modules; and
a processor communicatively coupled to the memory, the processor operable to execute the one or more modules to:
determine a first image attribute of a digital image of a specimen based upon at least one pixel characteristic of the digital image, the digital image captured by an image capture device;
generate an assessment metric based upon a comparison of the first image attribute with a second image attribute provided by a client device;
receive a diagnostic confidence metric corresponding to the specimen from the client device, the diagnostic confidence metric comprising an indication of whether a second review of the specimen occurred;
receive a diagnostic accuracy metric corresponding to the specimen from the client device, the diagnostic accuracy metric comprising an accuracy indication of a diagnosis of the anatomic pathology specimen;
receive a turn around time metric corresponding to the specimen from the client device, the turn around time metric comprising a time ranging from a case accession time to a case sign out time;
receive a clerical accuracy metric corresponding to the specimen from the client device, the clerical accuracy metric comprising a clerical accuracy parameter pertaining to the specimen; and
generate a score representing a proficiency corresponding to the specimen from the client device, the score based upon the assessment metric, the diagnostic confidence metric, the diagnostic accuracy metric, the turn around time metric, and the clerical accuracy metric.

16. The system as recited in claim 15, wherein the processor is further operable to execute the one or more modules to determine an image quality of the digital image and causes the image capture device to generate a second digital image of the specimen when the image quality is below a threshold.

17. The system as recited in claim 16, further comprising a staining device, the processor further operable to execute the one or more modules to cause the staining device to apply a stain to the specimen when the image quality is below the threshold.

18. The system as recited in claim 16, wherein the processor is further operable to execute the one or more modules to identify a region of interest of the specimen within the digital image; and compare an image characteristics of the region of interest with an image characteristic of the baseline region of interest within a baseline digital image.

19. The system as recited in claim 15, wherein the processor is further operable to execute the one or more modules to generate an alert and to cause transmission of the alert to a client device, the alert comprising a Uniform Resource Locator link providing access to the score.

20. The system as recited in claim 15, wherein the specimen comprises at least one of an anatomic pathology specimen or a clinical laboratory specimen.
